(19) United States
(12) Patent Application Publication
(10) Pub. No.: US 2026/0331043 A1
(43) Pub. Date: Oct. 22, 2026

(54) PIXEL DRIVING CIRCUIT, DISPLAY PANEL AND LIGHT-EMITTING CONTROL METHOD

(71) Applicants: Chengdu BOE Optoelectronics Technology Co., Ltd., Chengdu, Sichuan Province (CN); BOE Technology Group Co., Ltd., Beijing (CN); Beijing BOE Technology Development Co., Ltd., Beijing (CN)

(72) Inventors: Yao HUANG, Beijing (CN); Ming HU, Beijing (CN); Xiangdan DONG, Beijing (CN); Haijun QIU, Beijing (CN); Dongfang YANG, Beijing (CN); Yongliang ZHAO, Beijing (CN)

(21) Appl. No.: 18/852,623

(22) PCT Filed: Dec. 4, 2023
(86) PCT No.: PCT/CN2023/136191

§ 371 Date: Sep. 30, 2024

(51) Int. Cl. G09G 3/3233; G09G 3/32

(52) U.S. Cl. CPC G09G 3/3233; G09G 3/32; G09G 2300/043; G09G 2300/0819; G09G 2320/0233

(57) ABSTRACT

The present application relates to the field of display technology and discloses a pixel driving circuit, a display panel and a light-emitting control method. The pixel driving circuit includes: a conduction control subcircuit configured to, in response to a signal at a first light-emitting control signal terminal, make conduction between the gate of the drive transistor and the first node; a data writing subcircuit configured to, in response to a signal at a scanning signal terminal, write the drive signal into the first node; a coupling subcircuit configured to store the drive signal and a threshold voltage of the drive transistor; a first light-emitting control subcircuit.

### CROSS-REFERENCE TO RELATED APPLICATIONS

The present disclosure is a National Stage of International Application No. PCT/CN 2023/136191, filed on Dec. 4, 2023, the entire content of which is incorporated herein by reference.

### TECHNICAL FIELD

The present application relates to the field of display technology and provides a pixel driving circuit, a display panel and a light-emitting control method.

### BACKGROUND

In the related art, capacitance values of light-emitting devices in different pixel units correspond to pixel driving circuits are different, and different capacitance values may have different degrees of influence on drive signals and the like of the pixel driving circuits.

Especially, when the display panel is used to realize the display of a low grayscale picture, the displayed picture may have a large difference in brightness.

### SUMMARY

Embodiments of the present application provide a pixel driving circuit, a display panel, and a light-emitting control method, which are used for shielding the capacitance values of the light-emitting devices from the pixel circuits, so as to make a low grayscale picture to be displayed more uniformly in brightness through the pixel circuit.

The specific technical solutions provided by the present application are as follows.

In a first aspect, an embodiment of the present application provides a pixel driving circuit including: a drive transistor, a light-emitting device, a data writing subcircuit, a conduction control subcircuit, a coupling subcircuit, a first light-emitting control subcircuit, and a second light-emitting control subcircuit; where the drive transistor is configured to generate a drive current according to a drive signal; the conduction control subcircuit is coupled to a gate of the drive transistor and a first node, and is configured to, in response to a signal at a first light-emitting control signal terminal, make conduction between the gate of the drive transistor and the first node; the data writing subcircuit is coupled to the first node, and is configured to, in response to a signal at a scanning signal terminal, write the drive signal into the first node; the coupling subcircuit is coupled to the first node and a second electrode of the drive transistor, and is configured to store the drive signal and a threshold voltage of the drive transistor; the first light-emitting control subcircuit is coupled to a first electrode of the drive transistor, and is configured to, in response to a signal at a second light-emitting control signal terminal, provide a signal at a first power supply terminal to the first electrode of the drive transistor; and the second light-emitting control subcircuit is coupled between the second electrode of the drive transistor and the light-emitting device, and is configured to, in response to a signal at the first light-emitting control signal terminal, make conduction between the second electrode of the drive transistor and the light-emitting device.

Optionally, the second light-emitting control subcircuit includes: a first transistor; where a control terminal of the first transistor is coupled to the first light-emitting control signal terminal, a first terminal of the first transistor is coupled to the second electrode of the drive transistor, and a second terminal of the first transistor is coupled to the light-emitting device.

Optionally, the drive transistor is a single-gate transistor or a double-gate transistor; where when the drive transistor is the double-gate transistor, a first gate of the drive transistor is coupled to the conduction control subcircuit, and a second gate of the drive transistor is coupled to the second electrode of the drive transistor.

Optionally, the pixel driving circuit further includes a first capacitor; where a first terminal of the first capacitor is coupled to the first power supply terminal, and a second terminal of the first capacitor is coupled to the second electrode of the drive transistor.

Optionally, the data writing subcircuit includes: a second transistor; where a control terminal of the second transistor is coupled to the scanning signal terminal, a first terminal of the second transistor is coupled to a data signal terminal, and a second terminal of the second transistor is coupled to the first node.

Optionally, the conduction control subcircuit includes: a third transistor; where a control terminal of the third transistor is coupled to the first light-emitting control signal terminal, a first terminal of the third transistor is coupled to the gate of the drive transistor, and a second terminal of the third transistor is coupled to the first node.

Optionally, the first light-emitting control subcircuit includes: a fourth transistor; where a control terminal of the fourth transistor is coupled to the second light-emitting control signal terminal, a first terminal of the fourth transistor is coupled to the first power supply terminal, and a second terminal of the fourth transistor is coupled to the first electrode of the drive transistor.

Optionally, the coupling subcircuit includes: a second capacitor and a third capacitor; where a first terminal of the second capacitor is coupled to a second terminal of the third capacitor, and a second terminal of the second capacitor is coupled to the second electrode of the drive transistor; and a first terminal of the third capacitor is coupled to the first node.

Optionally, the pixel driving circuit further includes a first reset subcircuit; where the first reset subcircuit is coupled to the gate of the drive transistor, and is configured to, in response to a signal at a first reset signal terminal, provide a signal at a first initialization signal terminal to the gate of the drive transistor.

Optionally, the first reset subcircuit includes: a fifth transistor; where a control terminal of the fifth transistor is coupled to the first reset signal terminal, a first terminal of the fifth transistor is coupled to the first initialization signal terminal, and a second terminal of the fifth transistor is coupled to the gate of the drive transistor.

Optionally, the pixel driving circuit further includes a second reset subcircuit; where the second reset subcircuit is connected to the coupling subcircuit, and is configured to, in response to a signal at a second reset signal terminal, provide a signal at a second initialization signal terminal to the second electrode of the drive transistor.

Optionally, the second reset subcircuit includes: a sixth transistor; where a control terminal of the sixth transistor is coupled to the second reset signal terminal, a first terminal of the sixth transistor is coupled to an anode of the light-emitting device, and a second terminal of the sixth transistor is coupled to the second initialization signal terminal.

Optionally, the second reset subcircuit includes: an eighth transistor; where a control terminal of the eighth transistor is coupled to the second reset signal terminal, a first terminal of the eighth transistor is coupled to the second electrode of the drive transistor, and a second terminal of the eighth transistor is coupled to the second initialization signal terminal.

Optionally, the pixel driving circuit further includes a third reset subcircuit; where the third reset subcircuit is coupled to the first terminal of the second capacitor, and is configured to, in response to a signal at a first reset signal terminal, provide a signal at a first initialization signal terminal to the first terminal of the second capacitor.

Optionally, the third reset subcircuit includes: a seventh transistor; where a control terminal of the seventh transistor is coupled to the first reset signal terminal, a first terminal of the seventh transistor is coupled to the first terminal of the second capacitor, and a second terminal of the seventh transistor is coupled to the first initialization signal terminal.

In a second aspect, an embodiment of the present application also provides a display panel, including: a base substrate, including a plurality of sub-pixels, where the plurality of sub-pixels each include any the forgoing pixel driving circuit; the pixel driving circuit includes: a first transistor and a third transistor, and a control terminal of the first transistor is coupled to a control terminal of the third transistor; an orthographic projection of an active layer of the first transistor on the base substrate has a first overlapping region with an orthographic projection of a first signal line on the base substrate, where the first signal line in the first overlapping region is a gate of the first transistor; and an orthographic projection of an active layer of the third transistor on the base substrate has a second overlapping region with the orthographic projection of the first signal line on the base substrate, where the first signal line in the second overlapping region is the gate of the third transistor.

Optionally, the display panel includes: a first conductive layer, a second conductive layer, a first semi-conductive layer, a third conductive layer, a fourth conductive layer, and a fifth conductive layer; where the first conductive layer is on the base substrate, and the first conductive layer includes one electrode plate of a second capacitor and one electrode plate of a third capacitor; the second conductive layer is on a side of the first conductive layer away from the base substrate, and the second conductive layer includes another electrode plate of the second capacitor, another electrode plate of the third capacitor, and a first gate of the drive transistor; the first semi-conductive layer is on a side of the second conductive layer away from the base substrate, and the first semi-conductive layer includes an active layer of the drive transistor; the third conductive layer is on a side of the first semi-conductive layer away from the base substrate, and the third conductive layer includes a second gate of the drive transistor; the fourth conductive layer is on a side of the third conductive layer away from the base substrate, and the fourth conductive layer includes one electrode plate of a first capacitor; and the fifth conductive layer is on a side of the fourth conductive layer away from the base substrate, and the fifth conductive layer includes another electrode plate of the first capacitor.

Optionally, the second conductive layer includes a second control signal line; the third conductive layer includes a second auxiliary signal line and a third signal line, where a signal in the second control signal line and a signal in the second auxiliary signal line are a signal at a second reset signal terminal; the fourth conductive layer includes a first signal line, a fourth signal line, a fifth signal line, a sixth control signal line, a seventh control signal line and a first power signal line; and the fifth conductive layer includes a data signal line, a second power signal line, a sixth auxiliary signal line, and a seventh auxiliary signal line, where a signal in the sixth control signal line and a signal in the sixth auxiliary signal line are a signal at a first reset signal terminal, and a signal in the seventh control signal line and a signal in the seventh auxiliary signal line are a signal at a first initialization signal terminal.

Optionally, the second conductive layer includes a first gate of the first transistor, a first gate of a second transistor, a first gate of the third transistor, a first gate of a fourth transistor, a first gate of a fifth transistor, and a first gate of a seventh transistor; and the third conductive layer includes a second gate of the first transistor, a second gate of the second transistor, a second gate of the third transistor, a second gate of the fourth transistor, a second gate of the fifth transistor and a second gate of the seventh transistor.

In a third aspect, an embodiment of the present application further provides a light-emitting control method of any the foregoing pixel driving circuit, including: in a first stage: providing, by a first reset subcircuit, a signal at a first initialization signal terminal to the gate of the drive transistor in response to a signal at a first reset signal terminal, providing, by a second reset subcircuit, a signal at a second initialization signal terminal to the second electrode of the drive transistor in response to a signal at a second reset signal terminal, and, providing, by a third reset subcircuit, the signal at the first initialization signal terminal to a first terminal of the first capacitor in response to the signal at the first reset signal terminal; in a second stage: when a voltage at the second electrode of the drive transistor changes to a difference between the signal at the first initialization signal terminal and the threshold voltage, turning off the drive transistor, resetting a gate-source voltage of the drive transistor, and storing the threshold voltage of the drive transistor into a second capacitor; in a third stage: storing, by the data writing subcircuit, the drive signal into a third capacitor in response to the signal at the scanning signal terminal; and in a fourth stage: providing, by the conduction control subcircuit, the threshold voltage stored in the second capacitor and the drive signal stored in the third capacitor to the gate of the drive transistor in response to the signal at the first light-emitting control signal terminal, to cause the drive transistor to generate the drive current, providing, by the first light-emitting control subcircuit, the drive current generated by the drive transistor to the second light-emitting control subcircuit in response to the signal at the second light-emitting control signal terminal, and providing, by the second light-emitting control subcircuit, the drive current to the light-emitting device in response to the signal at the first light-emitting control signal terminal.

The beneficial effects of the present application are as follows.

In summary, in the embodiments of the present application, the pixel driving circuit, the display panel, and the light-emitting control method are provided. The pixel driving circuit includes: the drive transistor, the light-emitting device, the data writing subcircuit, the conduction control subcircuit, the coupling subcircuit, the first light-emitting control subcircuit, and the second light-emitting control subcircuit; where the drive transistor is configured to generate the drive current according to the drive signal; the conduction control subcircuit is coupled to the gate of the drive transistor and the first node, and is configured to, in response to the signal at the first light-emitting control signal terminal, make conduction between the gate of the drive transistor and the first node; the data writing subcircuit is coupled to the first node, and is configured to, in response to the signal at a scanning signal terminal, write the drive signal into the first node; the coupling subcircuit is coupled to the first node and the second electrode of the drive transistor, and is configured to store the drive signal and the threshold voltage of the drive transistor; the first light-emitting control subcircuit is coupled to the first electrode of the drive transistor, and is configured to, in response to the signal at the second light-emitting control signal terminal, provide the signal at the first power supply terminal to the first electrode of the drive transistor; and the second light-emitting control subcircuit is coupled between the second electrode of the drive transistor and the light-emitting device, and is configured to, in response to the signal at the first light-emitting control signal terminal, make conduction between the second electrode of the drive transistor and the light-emitting device. By the setting of the conduction control subcircuits, the capacitance value of the light-emitting device is effectively shielded from influencing the pixel circuit, so as to make a low grayscale picture to be displayed more uniformly in brightness through the pixel circuit.

Other features and advantages of the present application will be set forth in the subsequent specification and, in part, become apparent from the specification or are understood by implementing the present application. The objects and other advantages of the present application may be realized and obtained by means of the structure particularly indicated in the specification, the claims, and the accompanying drawings as written.

### BRIEF DESCRIPTION OF FIGURES

The accompanying drawings illustrated herein are used to provide a further understanding to the present application and form a part hereof, and the schematic embodiments of the present application and the description thereof are used to explain the present application and do not constitute an undue limitation thereof. The accompanying drawings are explained as below.

FIG. 1 is a schematic diagram of a pixel driving circuit in the related art.

FIG. 2 is a schematic diagram of a connection in a pixel driving circuit in an embodiment of the present application.

FIG. 3 is a circuit connection diagram of a first pixel driving circuit in an embodiment of the present application.

FIG. 4 is a circuit connection diagram of a second pixel driving circuit in an embodiment of the present application.

FIG. 5 is a circuit connection diagram of a third pixel driving circuit in an embodiment of the present application.

FIG. 6 is a circuit connection diagram of a fourth pixel driving circuit in an embodiment of the present application.

FIG. 7 is a schematic diagram of a timing of a pixel driving circuit in an embodiment of the present application.

FIG. 8 is a schematic diagram of a layout structure of a first conductive layer in a display panel in an embodiment of the present disclosure.

FIG. 9 is a schematic diagram of a layout structure of a second conductive layer in a display panel in an embodiment of the present disclosure.

FIG. 10 is a schematic diagram of a layout structure of a first semi-conductive layer in a display panel in an embodiment of the present disclosure.

FIG. 11 is a schematic diagram of a layout structure of a third conductive layer in a display panel in an embodiment of the present disclosure.

FIG. 12 is a schematic diagram of a first layout structure of a display panel in an embodiment of the present disclosure.

FIG. 13 is a schematic diagram of a layout structure of a fourth conductive layer in a display panel in an embodiment of the present disclosure.

FIG. 14 is a schematic diagram of a second layout structure of a display panel in an embodiment of the present disclosure.

FIG. 15 is a schematic diagram of a layout structure of a fifth conductive layer in a display panel in an embodiment of the present disclosure.

FIG. 16 is a schematic diagram of a third layout structure of a display panel in an embodiment of the present disclosure.

FIG. 17 is a flowchart of a light-emitting control method of a pixel driving circuit in an embodiment of the present application.

### DETAILED DESCRIPTION

In order to make the purpose, technical solutions and advantages of the embodiments of the present application clearer, the technical solutions of the present application will be described clearly and completely in the following in conjunction with the accompanying drawings in the embodiments of the present application, and it is obvious that the described embodiments are part of the embodiments of the technical solutions of the present application and not all of the embodiments. Based on the embodiments recorded in the present application, all other embodiments obtained by those skilled in the art without making creative labor fall within the scope of protection of the technical solution of the present application.

The terms “first”, “second”, etc., in the specification and claims of the present invention and the above-described accompanying drawings are used to distinguish between similar objects, and need not be used to describe a particular order or sequence. It should be understood that the term so used may be interchanged, where appropriate, so that the embodiments of the present invention described herein can be implemented using an order other than those illustrated or described herein.

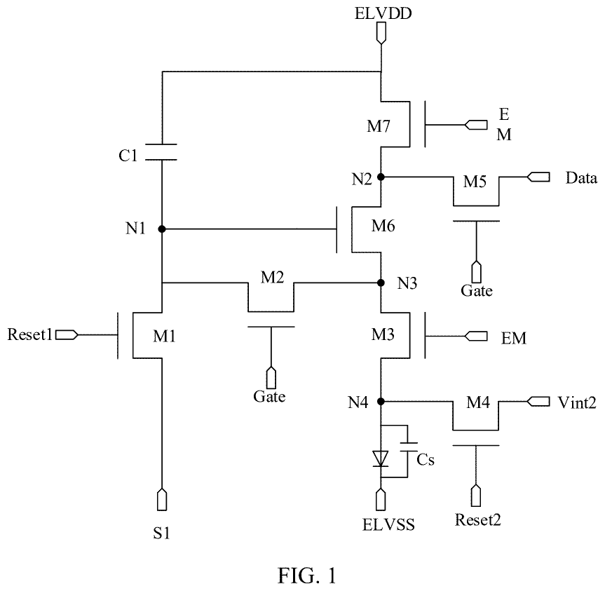

In the related art, referring to FIG. 1, during the operation of the pixel driving circuit, the light-emitting device itself generates a parasitic capacitor, and a capacitance value of this parasitic capacitor may affect a drive signal, etc., of the pixel driving circuit. When the display panel is used to realize the display of a low grayscale picture, capacitance values of light-emitting devices in different pixel driving circuits are different, which causes the displayed picture to have a large difference in brightness.

The preferred embodiment of the present application is described in detail below in conjunction with the accompanying drawings.

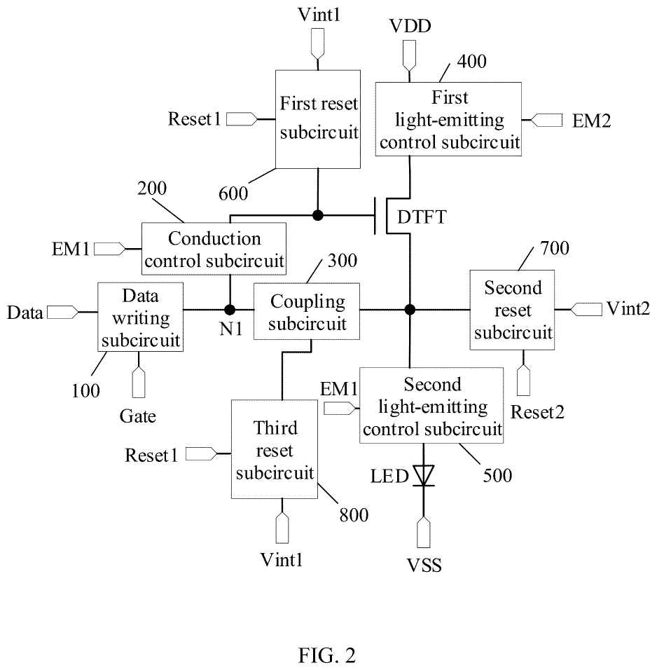

Referring to FIG. 2, a pixel driving circuit proposed in an embodiment of the present application includes: a drive transistor DTFT, a light-emitting device (LED), a data writing subcircuit 100, a conduction control subcircuit 200, a coupling subcircuit 300, a first light-emitting control subcircuit 400, and a second light-emitting control subcircuit 500. It is herein to be supplemented that the above light-emitting device may also be an OLED (organic light-emitting diode), micro LED, mini LED, inorganic light-emitting device, etc., and OLED is used as an example in the embodiments of the present application to expand the description.

The above-described drive transistor DTFT is configured to generate a drive current in accordance with a drive signal.

The conduction control subcircuit 200 is coupled to a gate of the drive transistor DTFT and a first node N1, and is configured to, in response to a signal at a first light-emitting control signal terminal EM1, make conduction between the gate of the drive transistor DTFT and the first node N1.

The data writing subcircuit 100 is coupled to the first node N1, and is configured to, in response to a signal at a scanning signal terminal Gate, write the drive signal into the first node N1.

The coupling subcircuit 300 is coupled to the first node N1 and a second electrode of the drive transistor DTFT, and is configured to store the drive signal and a threshold voltage of the drive transistor DTFT.

The first light-emitting control subcircuit 400 is coupled to a first electrode of the drive transistor DTFT, and is configured to, in response to a signal at a second light-emitting control signal terminal EM2, provide a signal at a first power supply terminal VDD to the first electrode of the drive transistor DTFT.

The second light-emitting control subcircuit 500 is coupled between the second electrode of the drive transistor DTFT and the light-emitting device LED, and is configured to, in response to a signal at the first light-emitting control signal terminal EM1, make conduction between the second electrode of the drive transistor DTFT and the light-emitting device LED.

Each of the above-described subcircuits and the like are described in detail below.

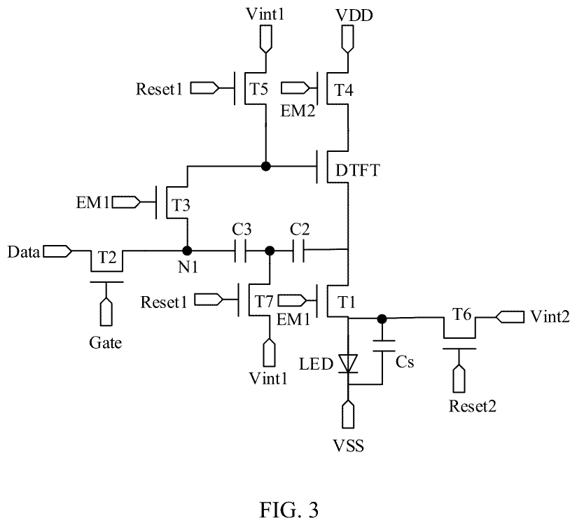

Referring to FIG. 3, the above-described second light-emitting control subcircuit 500 includes: a first transistor T1.

A connection relationship between the first transistor T1 and other devices in FIG. 3 is as follows. A control terminal of the first transistor T1 is coupled to the first light-emitting control signal terminal EM1, the first terminal of the first transistor T1 is coupled to the second electrode of the drive transistor DTFT, and the second terminal of the first transistor T1 is coupled to the light-emitting device LED.

During the implementation, when the signal at the first light-emitting control signal terminal EM1 is at a high level, the first transistor T1 is turned on, and the driving current generated by the drive transistor DTFT is provided to an anode of the light-emitting device LED through the turned-on first transistor T1 to cause the light-emitting device LED to emit light.

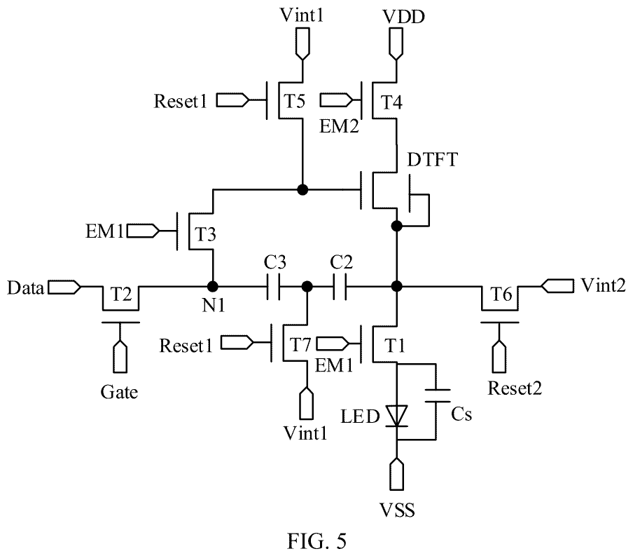

Referring to FIG. 5, the above-described drive transistor DTFT is a single-gate transistor or a double-gate transistor.

When the drive transistor DTFT is the double-gate transistor, a first gate of the drive transistor DTFT is coupled to the conduction control subcircuit 200, and a second gate of the drive transistor DTFT is coupled to the second electrode of the drive transistor DTFT.

Compared to the single-gate transistor, the grayscale control capability of the drive transistor DTFT is increased through the double-gate transistor increases, which can reduce the influence of the parasitic capacitor of the light-emitting device LED on the driving current generated by the drive transistor DTFT, and thus make the display brightness of the display panel more uniform.

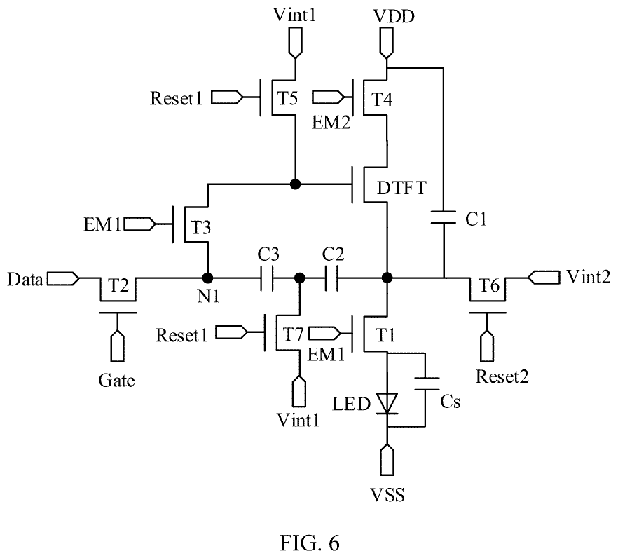

Furthermore, referring to FIG. 6, the pixel driving circuit further includes a first capacitor C1.

A connection relationship between the first capacitor C1 and the other devices in FIG. 6 is as follows. A first terminal of the first capacitor C1 is coupled to the first power supply terminal VDD, and a second terminal of the first capacitor C1 is coupled to the second electrode of the drive transistor DTFT.

Before adding the first capacitor C1, the driving current is calculated by the following formula (1).

Ids=½k(Vgs−Vth)²=½*k*((Data−vinit))\hat{ }2 Formula (1)

After the first capacitor C1 is added, the drive current is calculated by the following formula (2).

Ids=C1/(Cst+C1)*½k(Vgs−Vth)²=C1/(Cst+C1)*½*k*((data−vinit))\hat{ }2 Formula (2)

Where, Cst=(C1*C2)/(C1+C2).

It can be seen that the formula for calculating the drive current is more delicate by the addition of the first capacitor C1, which enables the drive current to be further regulated and thus adjusts the display brightness of the picture.

Referring to FIG. 3, the above-described data writing subcircuit 100 includes: a second transistor T2.

A connection relationship between the second transistor T2 and other devices in FIG. 3 is as follows. A control terminal of the second transistor T2 is coupled to the scanning signal terminal Gate, a first terminal of the second transistor T2 is coupled to a data signal terminal Data, and a second terminal of the second transistor T2 is coupled to the first node N1.

During the implementation, when the signal at the scanning signal terminal Gate is at a high level, the second transistor T2 is turned on, and the signal at the data signal terminal Data is provided to the first node N1 via the turned-on second transistor T2.

Referring to FIG. 3, the above-described conduction control subcircuit 200 includes: a third transistor T3.

A connection relationship between the third transistor T3 and the other devices in FIG. 3 is as follows. A control terminal of the third transistor T3 is coupled to the first light-emitting control signal terminal EM1, a first terminal of the third transistor T3 is coupled to the gate of the drive transistor DTFT, and a second terminal of the third transistor T3 is coupled to the first node N1.

During the implementation, when the signal at the first light-emitting control signal terminal EM1 is at a high level, the third transistor T3 is turned on, and the signal at the data signal terminal Data in the first node N1 is provided to the gate of the drive transistor DTFT via the turned-on third transistor T3.

Referring to FIG. 3, the above-described first light-emitting control subcircuit 400 includes: a fourth transistor T4.

A connection relationship between the fourth transistor T4 and the other devices in FIG. 3 is as follows. A control terminal of the fourth transistor T4 is coupled to the second light-emitting control signal terminal EM2, a first terminal of the fourth transistor T4 is coupled to the first power supply terminal VDD, and a second terminal of the fourth transistor T4 is coupled to the first electrode of the drive transistor DTFT.

During the implementation, when the signal at the second light-emitting control signal terminal EM2 is at a high level, the fourth transistor T4 is turned on, and the signal at the first power supply terminal VDD is provided to the first electrode of the drive transistor DTFT via the turned-on fourth transistor T4.

Referring to FIG. 3, the above-described coupling subcircuit 300 includes: a second capacitor C2 and a third capacitor C3.

A connection relationship of the second capacitor C2 and the third capacitor C3 with the other devices in FIG. 3 as follows. A first terminal of the second capacitor C2 is coupled to a second terminal of the third capacitor C3, and a second terminal of the second capacitor C2 is coupled to the second electrode of the drive transistor DTFT.

A first terminal of the third capacitor C3 is coupled to the first node N1.

During the implementation, the threshold voltage of the drive transistor DTFT can be obtained when the gate-source voltage of the drive transistor DTFT is reset, and then the above threshold voltage is stored into the second capacitor C2. After the third transistor T3 is turned on, the threshold voltage stored in the second capacitor C2 can be provided to the gate of the drive transistor DTFT via the turned-on third transistor T3. When the drive signal is written into the first node N1, the above drive signal is further stored into the third capacitor C3, so that when the third transistor T3 is turned on, the drive signal stored into the third capacitor C3 can be provided to the gate of the drive transistor DTFT via the turned-on third transistor T3.

Furthermore, referring to FIG. 3, the pixel driving circuit further includes a first reset subcircuit 600.

The first reset subcircuit 600 is coupled to the gate of the drive transistor DTFT, and is configured to provide, in response to a signal at a first reset signal terminal Reset1, a signal at a first initialization signal terminal Vint1 to the gate of the drive transistor DTFT.

Referring to FIG. 3, the above-described first reset subcircuit 600 includes: a fifth transistor T5.

A connection relationship between the fifth transistor T5 and the other devices in FIG. 3 is as follows. A control terminal of the fifth transistor T5 is coupled to the first reset signal terminal Reset1, a first terminal of the fifth transistor T5 is coupled to the first initialization signal terminal Vint1, and a second terminal of the fifth transistor T5 is coupled to the gate terminal of the drive transistor DTFT.

During the implementation, when the signal at the first reset signal terminal Reset1 is at a high level, the fifth transistor T5 is turned on, and the signal at the first initialization signal terminal Vint1 is provided to the gate of the drive transistor DTFT via the turned-on fifth transistor T5, thereby resetting the gate of the drive transistor DTFT.

Furthermore, referring to FIG. 3, the pixel driving circuit further includes a second reset subcircuit 700.

The second reset subcircuit 700 is coupled to the coupling subcircuit, and is configured to, in response to a signal at a second reset signal terminal Reset2, provide a signal at a second initialization signal terminal Vint2 to the second electrode of the drive transistor DTFT.

Referring to FIG. 3, in the embodiment, the above-described second reset subcircuit 700 includes: a sixth transistor T6.

A connection relationship between the sixth transistor T6 and the other devices in FIG. 3 is as follows. A control terminal of the sixth transistor T6 is coupled to the second reset signal terminal Reset2, a first terminal of the sixth transistor T6 is coupled to an anode of the light-emitting device, and a second terminal of the sixth transistor T6 is coupled to the second initialization signal terminal Vint2.

During the implementation, when the signal at the second reset signal terminal Reset2 is at a high level, the sixth transistor T6 is turned on, and the signal at the second initialization signal terminal Vint2 is provided to the anode of the light-emitting device via the turned-on sixth transistor T6, thereby resetting the anode of the light-emitting device.

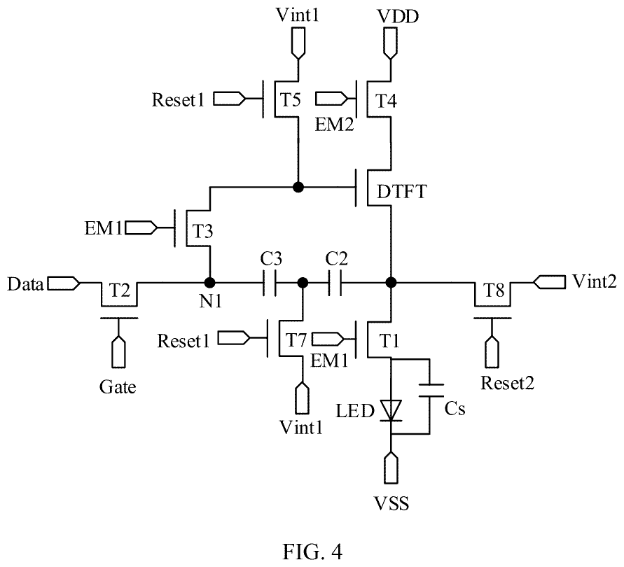

Referring to FIG. 4, in another embodiment, the above-described second reset subcircuit 700 includes: an eighth transistor T8.

A connection relationship between the eighth transistor T8 and the other devices in FIG. 3 is as follows. A control terminal of the eighth transistor T8 is coupled to the second reset signal terminal Reset2, a first terminal of the eighth transistor T8 is coupled to the second electrode of the drive transistor DTFT, and a second terminal of the eighth transistor T8 is coupled to the second initialization signal terminal Vint2.

During the implementation, when the signal at the second reset signal terminal Reset2 is at a high level, the eighth transistor T8 is turned on, and the signal at the second initialization signal terminal Vint2 is provided to the second electrode of the drive transistor DTFT via the turned-on eighth transistor T8, thereby resetting the second electrode of the drive transistor DTFT.

In the following description, the second reset subcircuit 700 including the sixth transistor T6 is described in detail.

Furthermore, referring to FIG. 3, the pixel driving circuit further includes a third reset subcircuit 800.

Referring to FIG. 3, the third reset subcircuit 800 is coupled to the first terminal of the second capacitor C2, and is configured to provide a signal at the first initialization signal terminal Vint1 to the first terminal of the second capacitor C2 in response to a signal at the first reset signal terminal Reset1.

Referring to FIG. 3, the above-described third reset subcircuit 800 includes: a seventh transistor T7.

A connection relationship between the seventh transistor T7 and the other devices in FIG. 3 is follows. A control terminal of the seventh transistor T7 is coupled to the first reset signal terminal Reset1, a first terminal of the seventh transistor T7 is coupled to the first terminal of the second capacitor C2, and a second terminal of the seventh transistor T7 is coupled to the first initialization signal terminal Vint1.

During the implementation, when the signal at the first reset signal terminal Reset1 is at a high level, the seventh transistor T7 is turned on, and the signal at the first initialization signal terminal Vint1 is provided to the first terminal of the second capacitor C2 via the turned-on seventh transistor T7 to reset the second capacitor C2 as well as the third capacitor C3 which is coupled to the second capacitor C2.

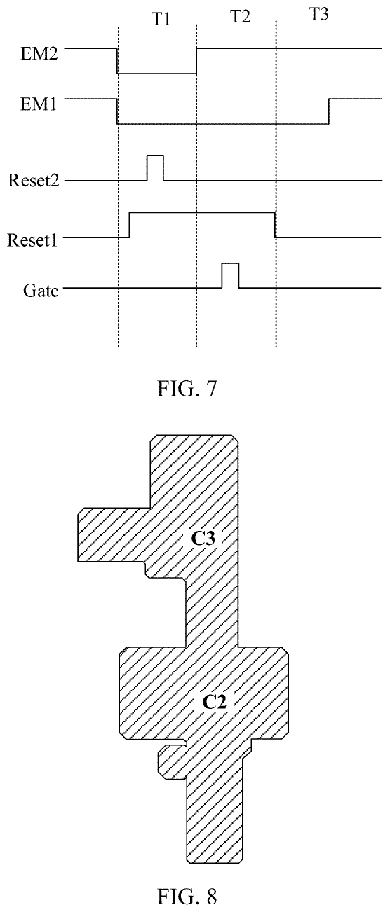

The operating process of the pixel driving circuit in the embodiment of the present application is described in detail below in connection with the timing in FIG. 7.

In timing stage T1: EM1=0, EM2=0, Reset1=1, Reset2=1, Gate=0.

When the signal at the first reset signal terminal Reset1 is at a high level, the fifth transistor T5 is turned on, and the signal at the first initialization signal terminal Vint1 is provided to reset the gate of the drive transistor DTFT via the turned-on fifth transistor T5. When the signal at the second reset signal terminal Reset2 is at a high level, the sixth transistor T6 is turned on, and the signal at the second initialization signal terminal Vint2 is provided to reset the second electrode of the drive transistor DTFT via the turned-on sixth transistor T6. When the signal at the first reset signal terminal Reset1 is at a high level, the seventh transistor T7 is turned on, and the signal at the first initialization signal terminal Vint1 is provided to reset the second terminal of the third capacitor C3 and the first terminal of the second capacitor C2 via the turned-on seventh transistor T7.

In timing stage T2: EM1=0, EM2=1, Reset1=1, Reset2=0, Gate=1.

When the signal at the first reset signal terminal Reset1 is at a high level, the fifth transistor T5 is turned on, and the signal at the first initialization signal terminal Vint1 is provided to reset the gate of the drive transistor DTFT via the turned-on fifth transistor T5. When the signal at the second light-emitting control signal terminal EM2 is at a high level, the fourth transistor T4 is turned on, and the signal at the first power supply terminal VDD is provided to the first electrode of the drive transistor DTFT via the turned-on fourth transistor T4, so that the gate-source voltage of the drive transistor DTFT is reset to acquire the threshold voltage of the drive transistor DTFT, and the threshold voltage of the drive transistor DTFT is stored into the second capacitor C2.When the signal at the scanning signal terminal Gate is at a high level, the second transistor T2 is turned on, and the drive signal at the data signal terminal Data is provided to the first node N1 via the turned-on second transistor T2, and in turn the drive signal is stored into the third capacitor C3.

In timing stage T3: EM1 changes from 0 to 1, EM2=1, Reset1=0, Reset2=0, Gate=0.

When the second light-emitting control signal terminal EM2 is at a high level, the fourth transistor T4 is turned on. The signal at the first power supply terminal VDD is provided to the drive transistor DTFT via the turned-on fourth transistor T4. When the signal at the first light-emitting control signal terminal EM1 changes from a low level to a high level, the first transistor T1 and the third transistor T3 are both turned on, and the threshold voltage stored into the second capacitor C2 and the drive signal stored into the third capacitor C3 are provided to the gate of the drive transistor DTFT via the turned-on third transistor T3. The drive transistor DTFT generates a drive current based on the drive signal and the threshold voltage, and the drive current is provided to the light-emitting device LED via the turned-on first transistor T1, thereby causing the light-emitting device LED to emit light.

Based on the same inventive concept, a display panel is provided in an embodiment of the present application, including: a base substrate, including a plurality of sub-pixels, where the plurality of sub-pixels each include the foregoing pixel driving circuit; the pixel driving circuit includes: a first transistor T1 and a third transistor T3, and a control terminal of the first transistor T1 is coupled to a control terminal of the third transistor T3; an orthographic projection of an active layer of the first transistor T1 on the base substrate has a first overlapping region with an orthographic projection of a first signal line on the base substrate, where the first signal line in the first overlapping region is a gate of the first transistor T1; and an orthographic projection of an active layer of the third transistor T3 on the base substrate has a second overlapping region with the orthographic projection of the first signal line on the base substrate, where the first signal line in the second overlapping region is the gate of the third transistor T3.

FIGS. 8 to 13 are schematic diagrams of layers of a pixel driving circuit provided in some embodiments of the present disclosure. Where, the examples shown in FIGS. 8 to 13 are illustrated with a pixel driving circuit for a sub-pixel. Where, FIGS. 8 to 13 also show a first signal line, a second control signal line, a second auxiliary signal line, a third signal line, a fourth signal line, a fifth signal line, a sixth control signal line, a seventh control signal line, a first power signal line, a data signal line, a second power signal line, a sixth auxiliary signal line, a seventh auxiliary signal line, and the like electrically coupled to the pixel driving circuit. Among them, the first power signal lines are arranged in a mesh, the sixth control signal line and the seventh control signal line are arranged in the fourth conductive layer in a first direction F1, and the sixth auxiliary signal line and the seventh auxiliary signal line are arranged in the fifth conductive layer in a second direction F2. The above setup can be designed and determined according to the needs of the actual application, and will not be limited herein.

Referring to FIGS. 8 to 13, the above-described display panel includes: a first conductive layer, a second conductive layer, a first semi-conductive layer, a third conductive layer, a fourth conductive layer, and a fifth conductive layer.

Referring to FIG. 8, the first conductive layer is on the base substrate, and the first conductive layer includes one electrode plate of the second capacitor C2 and one electrode plate of the third capacitor C3.

Exemplarily, the first conductive layer is provided on the base substrate. The first conductive layer may include: one electrode plate of the second capacitor C2, and one electrode plate of the third capacitor C3. In addition, an insulating layer is formed on the above-described first conductive layer for protecting the above-described first conductive layer.

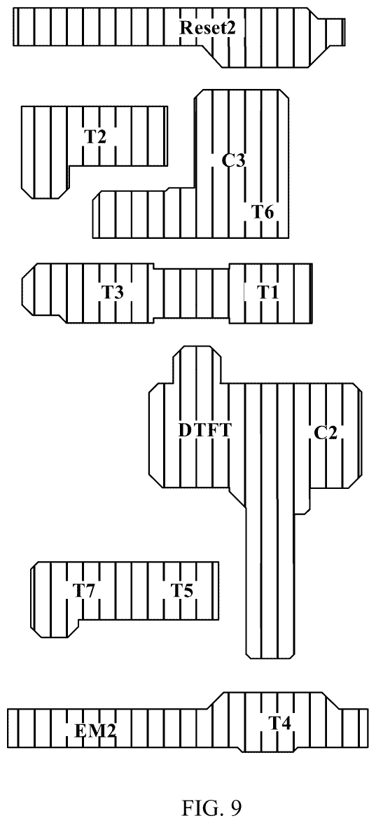

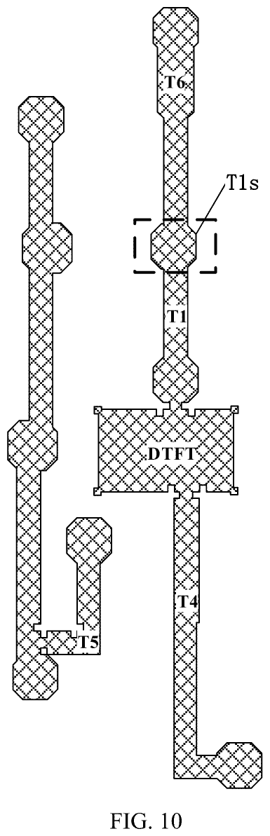

Referring to FIG. 9, the second conductive layer is located on a side of the first conductive layer away from the base substrate, and the second conductive layer includes another electrode plate of the second capacitor C2, another electrode plate of the third capacitor C3, and a first gate of the drive transistor DTFT.

Exemplarily, the second conductive layer is provided on the side of the first conductive layer away from the base substrate, so as to be insulated from the first conductive layer. The second conductive layer may include: another electrode plate of the second capacitor C2 and another electrode plate of the third capacitor C3. The another electrode plate of the above-described second capacitor C2 and the one electrode plate of the second capacitor C2 constitute the second capacitor C2, and the another electrode plate of the above-described third capacitor C3 and the one electrode plate of the third capacitor C3 constitute the third capacitor C3.In addition, it should be noted that when the drive transistor DTFT is the double-gate transistor, the first gate of the drive transistor DTFT is also provided in the first conductive layer.

In addition, the second conductive layer includes a second control signal line. Here, the signal transmitted in the second control signal line is the signal at the second reset signal terminal Reset2. It should be noted that the signal at the second reset signal terminal Reset2 is transmitted in the second auxiliary signal line provided in the third conductive layer in addition to being transmitted in the second control signal line in the second conductive layer.

It should also be noted that the first transistor T1, the second transistor T2, the third transistor T3, the fourth transistor T4, the fifth transistor T5, and the seventh transistor T7 in the embodiments of the present application may also be set up as the double-gate transistors.

Exemplarily, the second conductive layer described above includes a first gate of the first transistor T1, a first gate of the second transistor T2, a first gate of the third transistor T3, a first gate of the fourth transistor T4, a first gate of the fifth transistor T5, and a first gate of the seventh transistor T7.

In FIG. 9, a region corresponding to T1 is a region in which the first gate of the first transistor T1 is located, a region corresponding to T2 is a region in which the first gate of the second transistor T2 is located, a region corresponding to T3 is a region in which the first gate of the third transistor T3 is located, a region corresponding to T4 is a region in which the first gate of the fourth transistor T4 is located, a region corresponding to T5 is a region in which the first gate of the fifth transistor T5 is located, and a region corresponding to T7 is a region in which the first gate of the seventh transistor T7 is located.

Referring to FIG. 10, the first semi-conductive layer is on a side of the second conductive layer away from the base substrate, and the first semi-conductive layer includes an active layer of the drive transistor DTFT.

Exemplarily, the first semi-conductive layer may be formed by patterning Indium Gallium Zinc Oxide (IGZO) material. The first semi-conductive layer may be used to make the active layer of the above-described drive transistor DTFT as well as the active layers of other transistors, and each of the active layers may include a first region, a second region, and a first channel region between the first region and the second region. It should be noted that the first region and the second region described above may be a conductivity region formed by a region of the first semi-conductive layer doped with an n-type impurity or a p-type impurity, so that the first region and the second region may be used as a source region and a drain region of the active layer that are to be electrically connected. Furthermore, an insulating layer is formed on the above-described first semi-conductive layer for protecting the above-described first semi-conductive layer.

It should be noted that, since the gate of the first transistor T1 and the gate of the third transistor T3 are connected to the first signal line, the orthographic projection of the active layer of the first transistor T1 on the base substrate has the first overlapping region with the orthographic projection of the first signal line on the base substrate. Exemplarily, the first signal line in the first overlapping region is the gate of the first transistor T1. The orthographic projection of the active layer of the third transistor T3 on the base substrate has the second overlapping region with the orthographic projection of the first signal line on the base substrate. Exemplary, the first signal line in the second overlapping region is the gate of the third transistor T3.

In FIG. 10, a region corresponding to T1 is a region in which the active layer of the first transistor T1 is located, a region corresponding to T4 is a region in which the active layer of the fourth transistor T4 is located, a region corresponding to T5 is a region in which the active layer of the fifth transistor T5 is located, and a region corresponding to T6 is a region in which the active layer of the sixth transistor T6 is located.

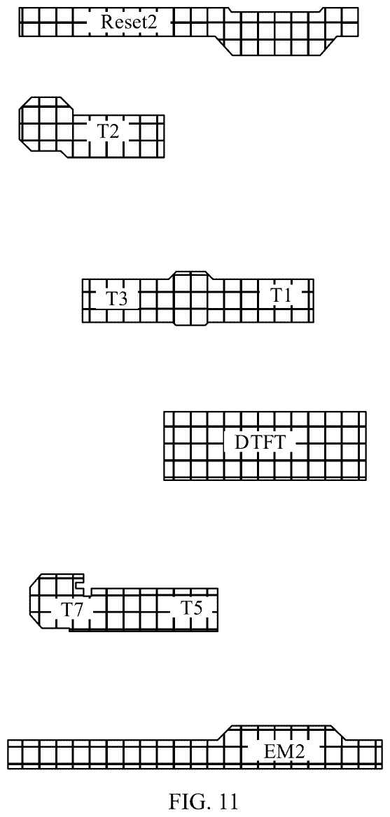

Referring to FIG. 11, the third conductive layer is on a side of the first semi-conductive layer away from the base substrate, and the third conductive layer includes the second gate of the drive transistor DTFT.

Exemplarily, an insulating layer is also provided between the third conductive layer and the second conductive layer in order to ensure the proper operation of each conductive layer.

Moreover, the third conductive layer is provided on the side of the first semi-conductive layer away from the base substrate, thereby be insulated from the first semi-conductive layer. When the drive transistor DTFT is the double-gate transistor, the second gate of the drive transistor DTFT is provided in the third conductive layer. It should be added that when the drive transistor DTFT is the single-gate transistor, this second gate is usually used as the gate of the drive transistor DTFT.

Accordingly, when the other transistors are also the double-gate transistors, the third conductive layer includes a second gate of the first transistor T1, a second gate of the second transistor T2, a second gate of the third transistor T3, a second gate of the fourth transistor T4, a second gate of the fifth transistor T5, and a second gate of the seventh transistor T7. It should be added that when the first transistor T1, the second transistor T2, the third transistor T3, the fourth transistor T4, the fifth transistor T5, and the seventh transistor T7 are set up as the single-gate transistors, this second gate is usually used as the gate of each transistor.

In addition, the third conductive layer includes the second auxiliary signal line and the third signal line, and the signal in the above-described second control signal line and the signal in the second auxiliary signal line are the signal at the second reset signal terminal Reset2. The signal transmitted in the above-described third signal line is the signal at the second light-emitting control signal terminal.

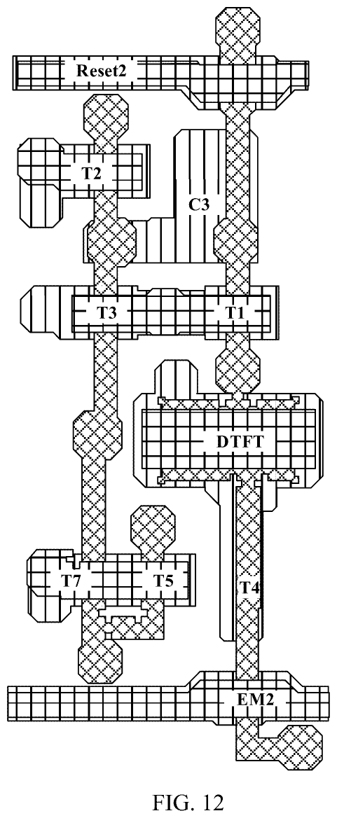

In FIG. 12, a region corresponding to T1 is a region in which the second gate of the first transistor T1 is located, a region corresponding to T2 is a region in which the second gate of a second transistor T2 is located, a region corresponding to T3 is a region in which the second gate of the third transistor T3 is located, a region corresponding to DTFT is a region in which the second gate of the drive transistor is located, a region corresponding to T5 is a region in which the second gate of the fifth transistor T5 is located, a region corresponding to T7 is a region in which the second gate of the seventh transistor T7 is located.

Referring to FIG. 12, FIG. 12 is a schematic diagram of a layout structure provided in some embodiments of the present application after the second conductive layer, the first semi-conductive layer, and the third conductive layer of the display panel are combined.

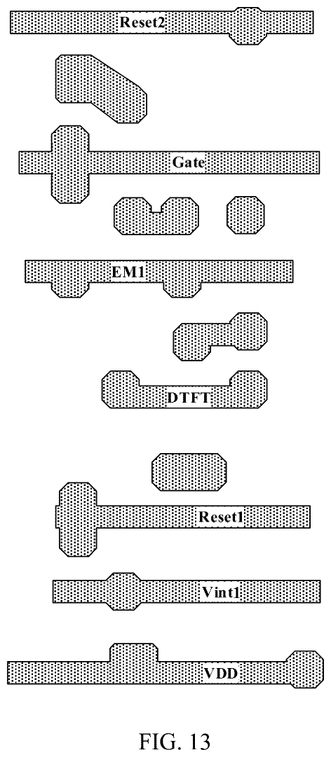

Referring to FIG. 13, the fourth conductive layer is on a side of the third conductive layer away from the base substrate, and the fourth conductive layer includes one electrode plate of the first capacitor C1.

Exemplarily, the fourth conductive layer is on the side of the third conductive layer away from the base substrate, and is insulated from the third conductive layer. The fourth conductive layer may include: one electrode plate of the first capacitor C1.

In addition, the fourth conductive layer includes the first signal line, the fourth signal line, the fifth signal line, the sixth control signal line, the seventh control signal line, and the first power signal line.

Referring to FIG. 13, the first signal line, the fourth signal line, the fifth signal line, the sixth control signal line, the seventh control signal line, and the first power signal line described above are substantially parallel in the fourth conductive layer, and the parallel may be the allowable parallel within the allowable error range.

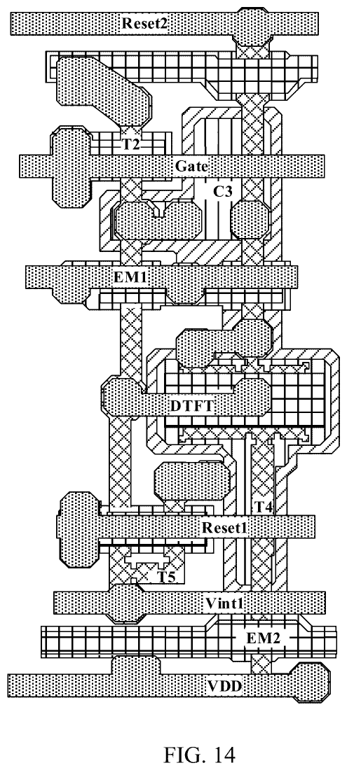

Referring to FIG. 14, FIG. 14 is a schematic diagram of a layout structure provided in some embodiments of the present application after the first conductive layer, the second conductive layer, the first semi-conductive layer, the third conductive layer, and the fourth conductive layer of the display panel are combined.

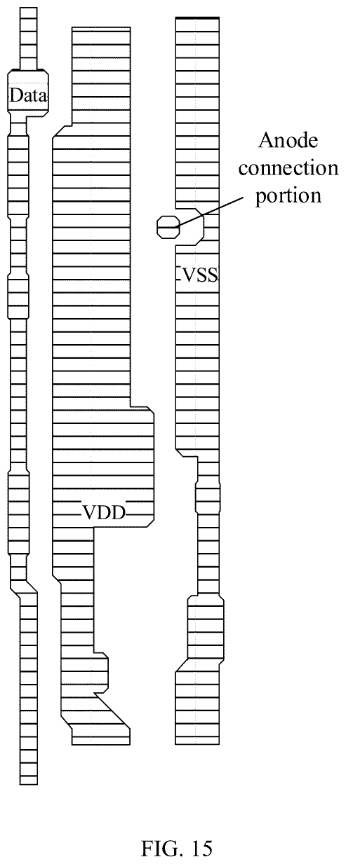

Referring to FIG. 15, the fifth conductive layer is on a side of the fourth conductive layer away from the base substrate, and the fifth conductive layer includes another electrode plate of the first capacitor C1.

Exemplarily, the fifth conductive layer is on the side of the fourth conductive layer away from the base substrate and is insulated from the fourth conductive layer. The fifth conductive layer may include: another electrode plate of the first capacitor C1, where the another electrode plate of the first capacitor C1 and the one electrode plate of the first capacitor C1 in the fourth conductive layer form the first capacitor C1.

In addition, the fifth conductive layer includes the data signal line, the second power signal line, the sixth auxiliary signal line, and the seventh auxiliary signal line. It should be noted that the signal in the sixth control signal line and the signal in the sixth auxiliary signal line are the signal at the first reset signal terminal Reset1, and the signal in the seventh control signal line and the signal in the seventh auxiliary signal line are the signal at the first initialization signal terminal Vint1.

Further, referring to FIG. 15, the anode of the light-emitting device is electrically connected to the source region-T1s (labeled in FIG. 10) of the first transistor T1 in the first semi-conductive layer through the fifth conductive layer, an adapter portion of the fourth conductive layer.

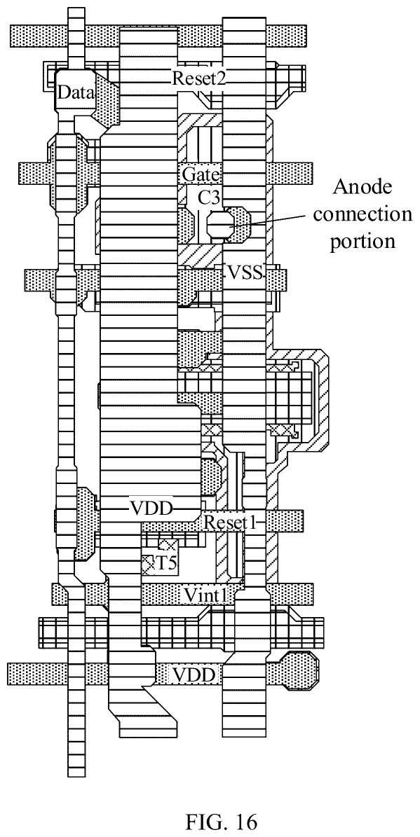

Referring to FIG. 16, FIG. 16 is a schematic diagram of a layout structure provided by some embodiments of the present application after the first conductive layer, the second conductive layer, the first semi-conductive layer, the third conductive layer, the fourth conductive layer, and the fifth conductive layer of the display panel are combined.

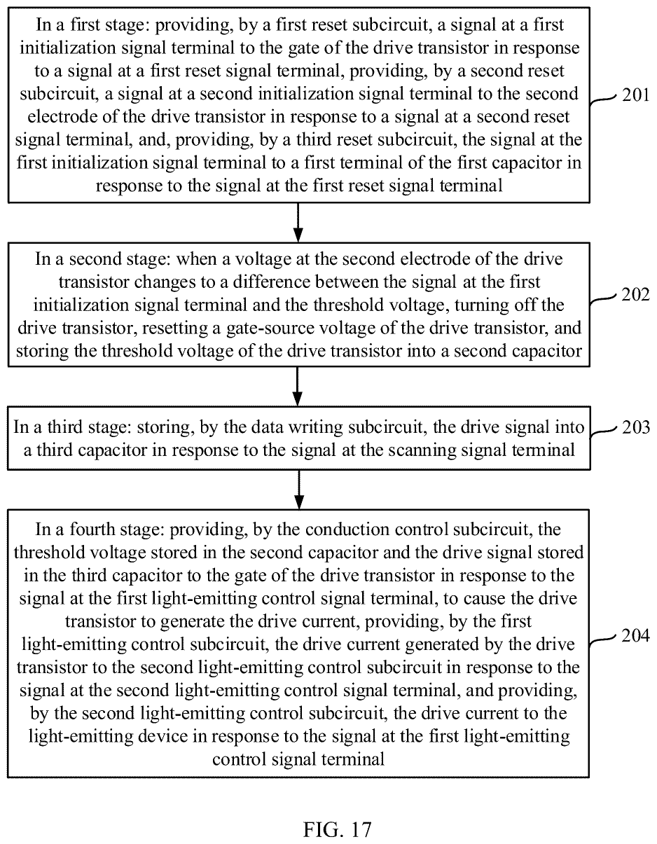

Based on the same inventive concept, a light-emitting control method of a pixel driving circuit is provided in an embodiment of the present application, shown with reference to FIG. 17, including the following.

Step 201, in a first stage: the first reset subcircuit 600, in response to a signal at the first reset signal terminal Reset1, provides a signal at the first initialization signal terminal Vint1 to the gate of the drive transistor DTFT; the second reset subcircuit 700, in response to a signal at the second reset signal terminal Reset2, provides a signal at the second initialization signal terminal Vint2 to the second electrode of the drive transistor DTFT; and the third reset subcircuit 800, in response to the signal at the first reset signal terminal Reset1, provides the signal at the first initialization signal terminal Vint1 to the first terminal of the first capacitor C1.

During the implementation, the drive transistor DTFT and the like in the pixel driving circuit are first reset by the first reset subcircuit 600, the second reset subcircuit 700, and the third reset subcircuit 800, so that the light-emitting device LED is not affected by the display effect of the previous frame.

Step 202, in a second stage: when a voltage at the second electrode of the drive transistor DTFT changes to a difference between the signal at the first initialization signal terminal Vint1 and the threshold voltage, the drive transistor DTFT is turned off, a gate-source voltage of the drive transistor DTFT is reset, and the threshold voltage of the drive transistor DTFT is stored into the second capacitor C2.

During the implementation, in order to make the drive current more accurate, under the action of the first power supply terminal VDD, the voltage of the second electrode of the drive transistor DTFT changes to the difference between the signal at the first initialization signal terminal Vint1 and the threshold voltage, and the gate-source voltage of the drive transistor DTFT is reset, so as to obtain the threshold voltage of the drive transistor DTFT, and store the threshold voltage into the second capacitor C2.

Step 203, in a third stage: the data writing subcircuit 100, in response to a signal at the scanning signal terminal Gate, stores the drive signal into the third capacitor C3.

During the implementation, when the signal at the scanning signal terminal Gate is valid, the drive signal is written into the first node N1 via the turned-on data writing subcircuit 100, and in turn is stored into the third capacitor C3.

Step 204, in a fourth stage: the conduction control subcircuit 200, in response to the signal at the first light-emitting control signal terminal EM1, provides the threshold voltage stored in the second capacitor C2 and the drive signal stored in the third capacitor C3 to the gate of the drive transistor DTFT to cause the drive transistor DTFT to generate the drive current; the first light-emitting control subcircuit 400, in response to the signal at the second light-emitting control signal terminal EM2, provides the drive current generated by the drive transistor DTFT to the second light-emitting control subcircuit 500; and the second light-emitting control subcircuit 500, in response to the signal at the first light-emitting control signal terminal EM1, provides the drive current to the light-emitting device LED.

During the implementation, in the light-emitting stage of the light-emitting device LED, when the signal at the first light-emitting control signal terminal EM1 is valid, the conduction control subcircuit 200 is turned on, and the threshold voltage stored in the second capacitor C2 and the drive signal stored in the third capacitor C3 are provided to the gate of the drive transistor DTFT via the turned-on conduction control subcircuit 200; and at the same time, the signal at the second light-emitting control signal terminal EM2 is valid, the first light-emitting control subcircuit 400 is turned on, and the drive transistor DTFT generates the driving current under the action of the first voltage source. The signal at the first light-emitting control signal terminal EM1 is valid, the second light-emitting control subcircuit 500 is turned on, and the driving current generated by the drive transistor DTFT is provided to the light-emitting device LED via the second light-emitting control subcircuit 500, so that the light-emitting device LED emits light.

In summary, in the embodiments of the present application, the pixel driving circuit, the display panel, and the light-emitting control method are provided. The pixel driving circuit includes: the drive transistor, the light-emitting device, the data writing subcircuit, the conduction control subcircuit, the coupling subcircuit, the first light-emitting control subcircuit, and the second light-emitting control subcircuit; where the drive transistor is configured to generate the drive current according to the drive signal; the conduction control subcircuit is coupled to the gate of the drive transistor and the first node, and is configured to, in response to the signal at the first light-emitting control signal terminal, make conduction between the gate of the drive transistor and the first node; the data writing subcircuit is coupled to the first node, and is configured to, in response to the signal at a scanning signal terminal, write the drive signal into the first node; the coupling subcircuit is coupled to the first node and the second electrode of the drive transistor, and is configured to store the drive signal and the threshold voltage of the drive transistor; the first light-emitting control subcircuit is coupled to the first electrode of the drive transistor, and is configured to, in response to the signal at the second light-emitting control signal terminal, provide the signal at the first power supply terminal to the first electrode of the drive transistor; and the second light-emitting control subcircuit is coupled between the second electrode of the drive transistor and the light-emitting device, and is configured to, in response to the signal at the first light-emitting control signal terminal, make conduction between the second electrode of the drive transistor and the light-emitting device. By the setting of the conduction control subcircuits, the capacitance value of the light-emitting device is effectively shielded from influencing the pixel circuit, so as to make a low grayscale picture to be displayed more uniformly in brightness through the pixel circuit.

It should be appreciated by those skilled in the art that embodiments of the present application may be provided as methods, systems, or computer program product systems. Thus, the present application may take the form of a fully hardware embodiment, a fully software embodiment, or an embodiment that combines software and hardware aspects. Further, the present application may take the form of a computer program product system implemented on one or more computer-usable storage media (including, but not limited to, disk memory, CD-ROM, optical memory, and the like) that contain computer-usable program code therein.

The present application is described with reference to flowcharts and/or block diagrams of methods, apparatus (systems), and computer program product systems according to the present application. It should be understood that each of the processes and/or boxes in the flowchart and/or block diagram, and the combination of processes and/or boxes in the flowchart and/or block diagram, may be implemented by computer program instructions. These computer program instructions may be provided to a processor of a general-purpose computer, a special-purpose computer, an embedded processor, or other programmable data-processing device to produce a machine such that the processor of the computer or other programmable data-processing device executes the instructions to produce a device for carrying out the functions specified in the one or more processes of the flowchart and/or the one or more boxes of the box diagram.

These computer program instructions may also be stored in the computer-readable memory capable of directing the computer or other programmable data processing device to operate in a particular manner such that the instructions stored in the computer-readable memory produce an article of manufacture including an instruction device that implements the function specified one or more processes of the flowchart and/or one or more boxes of the box diagram.

These computer program instructions may also be loaded onto a computer or other programmable data processing device such that a series of operational steps are performed on the computer or other programmable device to produce computer-implemented processing, such that the instructions executed on the computer or other programmable device provide steps for implementing the functionality specified in in the one or more processes of the flowchart and/or the one or more boxes of the box diagram.

Obviously, those skilled in the art can make various changes and variations to the present application without departing from the spirit and scope of the present application. Thus, to the extent that such modifications and variations of the present application are within the scope of the claims of the present application and their technical equivalents, the present application is intended to encompass such modifications and variations.

1. A pixel driving circuit, comprising: a drive transistor, a light-emitting device, a data writing subcircuit, a conduction control subcircuit, a coupling subcircuit, a first light-emitting control subcircuit, and a second light-emitting control subcircuit; wherein
the drive transistor is configured to generate a drive current according to a drive signal;
the conduction control subcircuit is coupled to a gate of the drive transistor and a first node, and is configured to, in response to a signal at a first light-emitting control signal terminal, make conduction between the gate of the drive transistor and the first node;
the data writing subcircuit is coupled to the first node, and is configured to, in response to a signal at a scanning signal terminal, write the drive signal into the first node;
the coupling subcircuit is coupled to the first node and a second electrode of the drive transistor, and is configured to store the drive signal and a threshold voltage of the drive transistor;
the first light-emitting control subcircuit is coupled to a first electrode of the drive transistor, and is configured to, in response to a signal at a second light-emitting control signal terminal, provide a signal at a first power supply terminal to the first electrode of the drive transistor; and
the second light-emitting control subcircuit is coupled between the second electrode of the drive transistor and the light-emitting device, and is configured to, in response to the signal at the first light-emitting control signal terminal, make conduction between the second electrode of the drive transistor and the light-emitting device.

2. The pixel driving circuit according to claim 1, wherein the second light-emitting control subcircuit comprises: a first transistor; wherein
a control terminal of the first transistor is coupled to the first light-emitting control signal terminal, a first terminal of the first transistor is coupled to the second electrode of the drive transistor, and a second terminal of the first transistor is coupled to the light-emitting device.

3. The pixel driving circuit according to claim 1, wherein the drive transistor is a single-gate transistor or a double-gate transistor; wherein
when the drive transistor is the double-gate transistor, a first gate of the drive transistor is coupled to the conduction control subcircuit, and a second gate of the drive transistor is coupled to the second electrode of the drive transistor.

4. The pixel driving circuit according to claim 1, further comprising: a first capacitor; wherein
a first terminal of the first capacitor is coupled to the first power supply terminal, and a second terminal of the first capacitor is coupled to the second electrode of the drive transistor.

5. The pixel driving circuit according to claim 1, wherein the data writing subcircuit comprises: a second transistor; wherein
a control terminal of the second transistor is coupled to the scanning signal terminal, a first terminal of the second transistor is coupled to a data signal terminal, and a second terminal of the second transistor is coupled to the first node.

6. The pixel driving circuit according to claim 1, wherein the conduction control subcircuit comprises: a third transistor; wherein
a control terminal of the third transistor is coupled to the first light-emitting control signal terminal, a first terminal of the third transistor is coupled to the gate of the drive transistor, and a second terminal of the third transistor is coupled to the first node.

7. The pixel driving circuit according to claim 1, wherein the first light-emitting control subcircuit comprises: a fourth transistor; wherein
a control terminal of the fourth transistor is coupled to the second light-emitting control signal terminal, a first terminal of the fourth transistor is coupled to the first power supply terminal, and a second terminal of the fourth transistor is coupled to the first electrode of the drive transistor.

8. The pixel driving circuit according to claim 1, wherein the coupling subcircuit comprises: a second capacitor and a third capacitor; wherein
a first terminal of the second capacitor is coupled to a second terminal of the third capacitor, and a second terminal of the second capacitor is coupled to the second electrode of the drive transistor; and
a first terminal of the third capacitor is coupled to the first node.

9. The pixel driving circuit according to claim 1, further comprising: a first reset subcircuit; wherein
the first reset subcircuit is coupled to the gate of the drive transistor, and is configured to, in response to a signal at a first reset signal terminal, provide a signal at a first initialization signal terminal to the gate of the drive transistor.

10. The pixel driving circuit according to claim 9, wherein the first reset subcircuit comprises: a fifth transistor; wherein
a control terminal of the fifth transistor is coupled to the first reset signal terminal, a first terminal of the fifth transistor is coupled to the first initialization signal terminal, and a second terminal of the fifth transistor is coupled to the gate of the drive transistor.

11. The pixel driving circuit according to claim 1, further comprising: a second reset subcircuit; wherein
the second reset subcircuit is connected to the coupling subcircuit, and is configured to, in response to a signal at a second reset signal terminal, provide a signal at a second initialization signal terminal to the second electrode of the drive transistor.

12. The pixel driving circuit according to claim 11, wherein the second reset subcircuit comprises: a sixth transistor; wherein
a control terminal of the sixth transistor is coupled to the second reset signal terminal, a first terminal of the sixth transistor is coupled to an anode of the light-emitting device, and a second terminal of the sixth transistor is coupled to the second initialization signal terminal.

13. The pixel driving circuit according to claim 11, wherein the second reset subcircuit comprises: an eighth transistor; wherein
a control terminal of the eighth transistor is coupled to the second reset signal terminal, a first terminal of the eighth transistor is coupled to the second electrode of the drive transistor, and a second terminal of the eighth transistor is coupled to the second initialization signal terminal.

14. The pixel driving circuit according to claim 1, further comprising: a third reset subcircuit; wherein
the third reset subcircuit is coupled to the first terminal of the second capacitor, and is configured to, in response to a signal at a first reset signal terminal, provide a signal at a first initialization signal terminal to the first terminal of the second capacitor.

15. The pixel driving circuit according to claim 14, wherein the third reset subcircuit comprises: a seventh transistor; wherein
a control terminal of the seventh transistor is coupled to the first reset signal terminal, a first terminal of the seventh transistor is coupled to the first terminal of the second capacitor, and a second terminal of the seventh transistor is coupled to the first initialization signal terminal.

16. A display panel, comprising:
a base substrate, comprising a plurality of sub-pixels, wherein the plurality of sub-pixels each comprise a pixel driving circuit according to claim 1;
the pixel driving circuit comprises: a first transistor and a third transistor, and a control terminal of the first transistor is coupled to a control terminal of the third transistor;
an orthographic projection of an active layer of the first transistor on the base substrate has a first overlapping region with an orthographic projection of a first signal line on the base substrate, wherein the first signal line in the first overlapping region is a gate of the first transistor; and
an orthographic projection of an active layer of the third transistor on the base substrate has a second overlapping region with the orthographic projection of the first signal line on the base substrate, wherein the first signal line in the second overlapping region is a gate of the third transistor.

17. The display panel according to claim 16, comprising: a first conductive layer, a second conductive layer, a first semi-conductive layer, a third conductive layer, a fourth conductive layer, and a fifth conductive layer; wherein
the first conductive layer is on the base substrate, and the first conductive layer comprises one electrode plate of a second capacitor and one electrode plate of a third capacitor;
the second conductive layer is on a side of the first conductive layer away from the base substrate, and the second conductive layer comprises another electrode plate of the second capacitor, another electrode plate of the third capacitor, and a first gate of the drive transistor;
the first semi-conductive layer is on a side of the second conductive layer away from the base substrate, and the first semi-conductive layer comprises an active layer of the drive transistor;
the third conductive layer is on a side of the first semi-conductive layer away from the base substrate, and the third conductive layer comprises a second gate of the drive transistor;
the fourth conductive layer is on a side of the third conductive layer away from the base substrate, and the fourth conductive layer comprises one electrode plate of a first capacitor; and
the fifth conductive layer is on a side of the fourth conductive layer away from the base substrate, and the fifth conductive layer comprises another electrode plate of the first capacitor.

18. The display panel according to claim 17, wherein the second conductive layer comprises a second control signal line;
the third conductive layer comprises a second auxiliary signal line and a third signal line, wherein a signal in the second control signal line and a signal in the second auxiliary signal line are a signal at a second reset signal terminal;
the fourth conductive layer comprises a first signal line, a fourth signal line, a fifth signal line, a sixth control signal line, a seventh control signal line and a first power signal line; and
the fifth conductive layer comprises a data signal line, a second power signal line, a sixth auxiliary signal line, and a seventh auxiliary signal line, wherein a signal in the sixth control signal line and a signal in the sixth auxiliary signal line are a signal at a first reset signal terminal, and a signal in the seventh control signal line and a signal in the seventh auxiliary signal line are a signal at a first initialization signal terminal.

19. The display panel according to claim 17, wherein the second conductive layer comprises a first gate of the first transistor, a first gate of a second transistor, a first gate of the third transistor, a first gate of a fourth transistor, a first gate of a fifth transistor, and a first gate of a seventh transistor; and
the third conductive layer comprises a second gate of the first transistor, a second gate of the second transistor, a second gate of the third transistor, a second gate of the fourth transistor, a second gate of the fifth transistor and a second gate of the seventh transistor.

20. A light-emitting control method of the pixel driving circuit according to claim 1, comprising:
in a first stage: providing, by a first reset subcircuit, a signal at a first initialization signal terminal to the gate of the drive transistor in response to a signal at a first reset signal terminal, providing, by a second reset subcircuit, a signal at a second initialization signal terminal to the second electrode of the drive transistor in response to a signal at a second reset signal terminal, and, providing, by a third reset subcircuit, the signal at the first initialization signal terminal to a first terminal of a first capacitor in response to the signal at the first reset signal terminal;
in a second stage: when a voltage at the second electrode of the drive transistor changes to a difference between the signal at the first initialization signal terminal and the threshold voltage, turning off the drive transistor, resetting a gate-source voltage of the drive transistor, and storing the threshold voltage of the drive transistor into a second capacitor;
in a third stage: storing, by the data writing subcircuit, the drive signal into a third capacitor in response to the signal at the scanning signal terminal; and
in a fourth stage: providing, by the conduction control subcircuit, the threshold voltage stored in the second capacitor and the drive signal stored in the third capacitor to the gate of the drive transistor in response to the signal at the first light-emitting control signal terminal, to cause the drive transistor to generate the drive current, providing, by the first light-emitting control subcircuit, the drive current generated by the drive transistor to the second light-emitting control subcircuit in response to the signal at the second light-emitting control signal terminal, and providing, by the second light-emitting control subcircuit, the drive current to the light-emitting device in response to the signal at the first light-emitting control signal terminal.
